(19) United States
(12) Patent Application Publication
(10) Pub. No.: US 2016/0140395 A1
(43) Pub. Date: May 19, 2016

(54) ADAPTIVE SAMPLING FOR EFFICIENT ANALYSIS OF EGO-CENTRIC VIDEOS

(71) Applicant: Xerox Corporation, Norwalk, CT (US)

(72) Inventors: JAYANT KUMAR, Webster, NY (US); SURVI KYAL, Rochester, NY (US); QUN LI, Webster, NY (US); EDGAR A. BERNAL, Webster, NY (US); RAJA BALA, Pittsford, NY (US)

(21) Appl. No.: 14/596,592

(22) Filed: Jan. 14, 2015

Related U.S. Application Data
(60) Provisional application No. 62/079,724, filed on Nov. 14, 2014.

(51) Int. Cl. G06K 9/00; G06K 9/46

(52) U.S. Cl. CPC G06K 9/00711; G06K 9/4604

(57) ABSTRACT

A method, non-transitory computer-readable medium, and apparatus for adaptive sampling an ego-centric video to extract features for performing an analysis are disclosed. For example, the method captures the ego-centric video, determines a spatio-temporal location of interest within the ego-centric video, applies an adaptive sampling centered around the spatio-temporal location of interest to obtain one or more spatio-temporal patches, extracts one or more features using the one or more spatio-temporal patches and performs an analysis based on the one or more features.

### CROSS REFERENCE TO RELATED APPLICATIONS

This application claims priority to U.S. Provisional Patent Application Ser. No. 62/079,724, filed Nov. 14, 2014, which is herein incorporated by reference in its entirety.

The present disclosure relates generally to sampling of spatio-temporal descriptors in videos for analysis and, more particularly, to a method and apparatus for adaptive sampling based feature computation in ego-centric videos for action classification.

### BACKGROUND

Multiclass human activity recognition is an interesting problem for a variety of applications. Traditionally, the problem has been addressed from video acquired with stationary cameras installed at fixed locations in the environment in which the human is operating.

In addition, current methods for analyzing videos for activity recognition consider an entire frame of the video. This is a very time consuming process and is computationally taxing. In addition, processing power and time are wasted on analyzing unimportant regions of the video frame.

Alternatively, a fixed portion of the video frame is analyzed. However, objects of interest within the video frame may move, change in size, and the like. As a result, analysis of the fixed portion of the video frame may not result in accurate activity recognition.

### SUMMARY

According to aspects illustrated herein, there are provided a method, a non-transitory computer-readable medium, and an apparatus for adaptive sampling an ego-centric video to extract features for performing analysis. One disclosed feature of the embodiments is a method that captures the ego-centric video, determines a spatio-temporal location of interest within the ego-centric video, applies an adaptive sampling centered around the spatio-temporal location of interest to obtain one or more spatio-temporal patches, extracts one or more features using the one or more spatio-temporal patches, and performs an analysis based on the one or more features.

Another disclosed feature of the embodiments is a non-transitory computer-readable medium having stored thereon a plurality of instructions, the plurality of instructions including instructions which, when executed by a processor, cause the processor to perform operations that capture the ego-centric video, determine a spatio-temporal location of interest within the ego-centric video, apply an adaptive sampling centered around the spatio-temporal location of interest to obtain one or more spatio-temporal patches, extract one or more features using the one or more spatio-temporal patches and perform an analysis based on the one or more features.

Another disclosed feature of the embodiments is an apparatus comprising a processor and a computer-readable medium storing a plurality of instructions which, when executed by the processor, cause the processor to perform operations that capture the ego-centric video, determine a spatio-temporal location of interest within the ego-centric video, apply an adaptive sampling centered around the spatio-temporal location of interest to obtain one or more spatio-temporal patches, extract one or more features using the one or more spatio-temporal patches and perform an analysis based on the one or more features.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of a head-mounted video device of the present disclosure;

FIG. 2 illustrates an example binary mask obtained by a hand segmentation module;

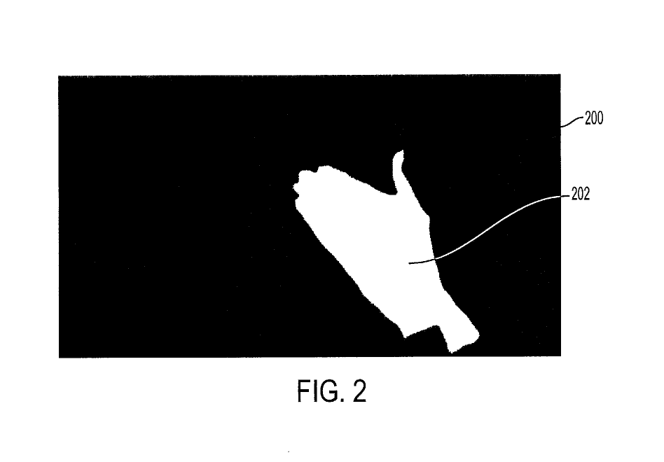

FIG. 3 illustrates an example spatio-temporal patch of the video;

FIG. 4 illustrates a graphical representation of the traditional approach for sampling and the adaptive sampling method of the present disclosure;

FIG. 5 illustrates an example series of ego-centric videos that are classified based on feature extraction;

FIG. 6 illustrates an example flow diagram of a method for adaptive sampling ego-centric videos to extract features for action classification; and

FIG. 7 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses a method, non-transitory computer-readable medium and an apparatus for adaptive sampling to extract features in ego-centric video captured by a wearable camera for a variety of analytics. In the practiced embodiment the analytics pertains to classifying the action that the user is performing. With current video analytics methods, the sampling methods for feature computation give equal importance to the entire video data, and thus are computationally taxing and time consuming, while at the same time sampling information that may be irrelevant to the task at hand.

In contrast, embodiments of the present disclosure perform adaptive sampling on one or more video frames of a first-person video or ego-centric video captured by a user. The adaptive sampling produces dense sampling in important regions of the video and sparse sampling in unimportant regions of the video. In addition, the adaptive sampling performs sampling on a sub-region of the frame for each video frame over a period of time. The sampling is adaptive as the location of the sub-region within the video frame may change from frame to frame or the dimensions or size of the sub-region within the video frame may change from frame to frame as objects of interest enter or leave the video frame. A spatio-temporal (ST) patch or descriptor may be obtained from the sub-region of the video frame. By performing adaptive-sampling-based feature computation on only a sub-region of the video frame, rather than sampling the entire video, the efficiency of classification of the videos is greatly improved.

In one embodiment, the one or more features may be extracted from ST patches or descriptors of the one or more video frames that are adaptively sampled. The one or more features may then be classified for a variety of different applications. For example, the currently disclosed methods may be used for testing for compliance in a procedure, providing real-time assistance in complex tasks, summarizing long video sequences, detecting anomalies, recognizing relevant activities, and the like.

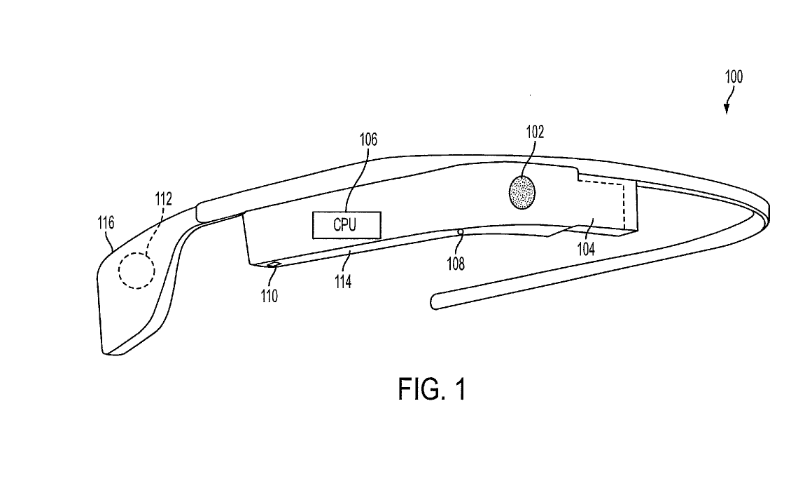

FIG. 1 illustrates an example of a head-mounted video device 100 of the present disclosure. In one embodiment, the head-mounted video device 100 may be a device, such as for example, Google Glass®. In one embodiment, the head-mounted video device 100 may include a camera 102, a display 104, a processor 106 (e.g., a central processing unit (CPU)), a microphone 108, one or more speakers 110 and a battery 112. In one embodiment, the processor 106, the camera 102, the microphone 108 and the one or more speakers 110 may be inside of or built into a housing 114. In one embodiment, the battery 112 may be inside of an arm 116.

It should be noted that FIG. 1 illustrates a simplified block diagram of the head-mounted video device 100. The head-mounted video device 100 may include other modules not shown, such as for example, a global positioning system (GPS) module, a memory module, a wireless connectivity module, and the like.

In one embodiment, the camera 102 may be used to capture ego-centric video. In one embodiment, ego-centric video may be defined as video that is captured from a perspective of a user wearing the head-mounted video device 100. In other words, the ego-centric video is a view of what the user is also looking at.

In one embodiment, the head-mounted video device may include an object of interest detection module and a region of interest detection module. In one embodiment, the object of interest detection module may identify the pixels belonging to the object of interest in each video frame. In one embodiment, the object of interest may be a hand, a body part, a face, or any other human body part. In some embodiments, the object of interest may be inanimate and can include a vehicle, a sign, a license plate, and the like. In one embodiment, the region of interest detection module may detect the region of interest based on a location of one or more pixels of the object of interest. In one embodiment, the object of interest may be detected using a segmentation algorithm on one or more frames of the ego-centric video to detect the pixels of the object of interest within the frame and create a binary mask. In one embodiment, the object of interest may be detected using a computer vision algorithm for object detection and localization.

In one embodiment, the object of interest may be a hand and any type of hand segmentation algorithm may be used to detect the hand pixels in the video frame. In one example of a hand segmentation algorithm, the head-mounted video device 100 may be trained to detect hands and the characteristic or characteristics used to train the hand detection (e.g., an RGB color value of the hand pixels) may be used to identify the hand pixels in the video frame.

However, the initial hand segmentation algorithm may contain some errors. As a result, image processing may be applied to the binary mask to help reduce instances of potential false positives and false negatives. In one embodiment, the image processing may be a set of morphological operations that may include dilation, erosion, opening and closing to fill up some of the smaller holes and eliminate some of the smaller mask structures.

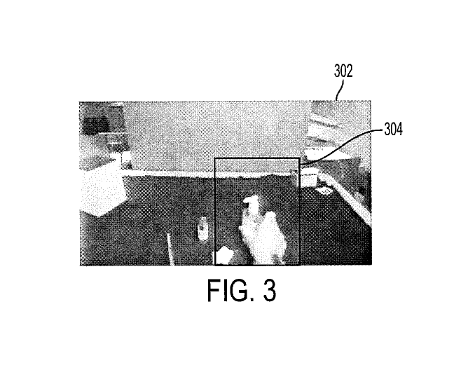

FIG. 3 illustrates a sub-region 302 of a frame with a spatio-temporal (ST) patch that is outlined by a box 304. It should be noted that the temporal dimension of the patch is not visible. In one embodiment, the sub-region 302 of the frame may have a predetermined shape with predetermined dimensions, may be dynamically changed based on context or may be both fixed with the predetermined dimensions for a certain number of frames and dynamically changed every n^{th} frame.

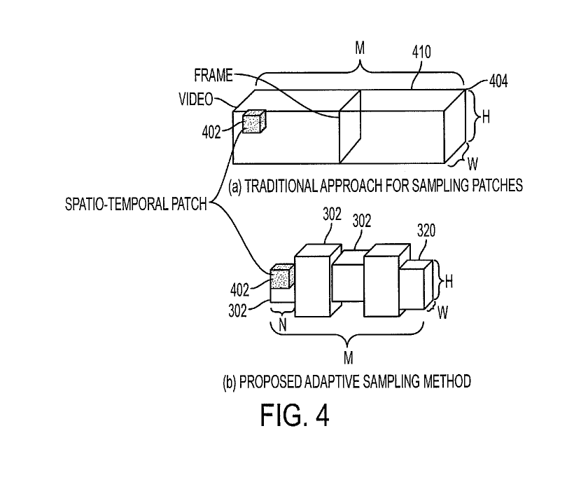

FIG. 4 illustrates graphically how the sub-region 302 has a predetermined dimensions and how the sub-region 302 is also dynamically changed. The graphical representation 410 illustrates a traditional sampling approach where a region of interest 402 is analyzed within an entire frame 404 over an entire number of frames or time duration. Time progresses from left to right in the graphical representation 410. The dimensions refer to a height h, a width w and a temporal length M labeled in FIG. 4.

In contrast, the embodiments of the present disclosure improve the efficiency of sampling the video frames by sampling only ST patches of a region of interest 402 within the sub-region 302. For example, the sub-region 302 may include an area of the video frame that likely includes an object of interest, but removes unimportant areas of the video frame that do not need to be analyzed. It is the premise of the present disclosure that the regions corresponding to the object of interest (e.g., the hand regions) provide important cues about the region of interest 402, particularly for those tasks involving significant hand-eye coordination. In other words, the sub-region 302 only needs to be processed and analyzed using the object of interest localization algorithms (e.g., hand segmentation algorithms) to find the region of interest 402 that includes the object of interest (e.g., a hand or hands) rather than processing and analyzing the entire video frame as required by previous methods. The proposed approach has the advantage of reduced computational cost in feature extraction since only a fraction of each video frame is being processed. Additionally, the method also results in improved action recognition accuracy due to the fact that the feature descriptors computed from salient portions of the video are more discriminative across different actions, while being consistent across different users performing the same action.

The graphical representation 420 illustrates a sub-region 302 having fixed dimensions for a first N number of frames (e.g., approximately 10-15 frames, but this number may vary and may depend on the frame rate) that contains the region of interest 402 (e.g., the user's hand). Similar to the graphical representation 410, time progresses from left to right. The dimensions refer to a height h, a width w and a temporal length M labeled in FIG. 4.

For example, it may be assumed that for a short duration (e.g., approximately 0.5 seconds) that the region of interest 402 does not move significantly. Then beginning with the N+1 frame, the dimensions of the sub-region 302 are dynamically changed and fixed with a different predetermined dimension for the next N frames, and so forth.

For example, the first N number of frames may include only a single hand of the user and the sub-region 302 may have predetermined dimensions that include the single hand of the user. At a frame N+1 the user's second hand may enter the ego-centric video and the sub-region 302 may need to be enlarged to include both hands of the user. Thus, the sub-region 302 may have larger predetermined dimensions for the second N frames compared to the first N frames. Subsequently, if one of the user's hands is removed from the frame, then the sub-region 302 may have smaller dimensions for the sub-region 302.

In one embodiment, the patches extracted from the region of interest 402 are referred to as spatio-temporal patches due to the fact that the patches are within a particular space at a particular time within the video frame. In other words, the ST patches may vary within the video frame and at different times over a duration of the ego-centric video.

Notably, unlike previous sampling techniques, the sub-region 302 is not fixed. For example, previous sampling techniques assumed that the region of interest will occur in a center of the video frame and only sampled the center of the video frame. However, with ego-centric videos, the region of interest may occur in different areas (e.g., along a bottom of the frame, along a top of the frame, along extreme sides of the frame, and the like) as the user's head moves. Thus, the sub-region 302 that includes the region of interest 402 may move around to different areas from frame to frame of the ego-centric video. The adaptive sampling methods disclosed herein can follow the region of interest 402 around different locations in the video frame by detecting where the hand is via the hand segmentation algorithms.

In one embodiment, in addition to changing the height and the width of sub-region 302, its temporal length is also modified at each sampling cycle. In one embodiment, operationally adaptive sampling may be accomplished as follows. Based on the locations of pixels associated with the object of interest (e.g., a hand), a spatio-temporal location of interest may be identified within the ego-centric video, which is a single pixel denoted C. In one embodiment, C is the centroid of all detected pixels of the object of interest in a given frame. Other rules may also be used to determine C. Next, a sampling probability mask P(x,y) is defined that indicates the probability of selecting a spatio-temporal patch at pixel location (x,y). The mask is centered about C.

In one embodiment, hard sampling may be performed, in which P(x,y) takes on a value of 1 for pixels inside a fixed spatio-temporal region centered around C, and a value of 0 for pixels outside the fixed spatio-temporal region. The fixed spatio-temporal region may be one of several shapes, including a cuboid, a cylinder, an elliptical cylinder, a sphere, an ellipsoid, and the like. In another embodiment, soft sampling may be performed in which the sampling probability mask takes on intermediate values between 0 and 1. In one embodiment, the mask is a Gaussian function centered about C, and the spatio-temporal patch at a given location is selected only if the Gaussian function at that location is larger than a uniformly distributed random number generated in the range between 0 and 1. With this operation, regions near C will be more densely sampled while regions farther away from C will be more sparsely sampled.

In one embodiment, the Gaussian function is spherically symmetric or isotropic. The parameters of the Gaussian function, namely the covariance matrix, may be determined experimentally through a technique such as cross-validation. In alternative embodiments, other monotonically decreasing sampling functions may be used to control the density of the samples.

In one embodiment, one or more features may be extracted from each one of the ST patches from the video frames. In one embodiment, the features may be detected using algorithms, such as, scale invariant feature transform (SIFT), histogram of oriented gradients (HOG), local binary patterns (LBP), and the like, may be used to extract one or more features. In addition, 3D versions of the algorithms may also be used (e.g., 3DSIFT, HOG-3D, space time interest points (STIP), and the like). For example, hand-engineered features may be detected using 3DSIFT, where 3DSIFT features of the ego-centric video are extracted at locations identified by the adaptive sampling. In one embodiment, trajectory based descriptors such as dense trajectories and its improved versions may also be used to compute features.

In another embodiment, a deep learning model may be used to extract the one or more features. One example of a deep learning model may be an Independent Subspace Analysis (ISA) network that is trained from ST patches extracted from a set of training ego-centric videos. In one embodiment, an ISA network includes two layers with square and square root non-linearities in the first layer and second layer, respectively.

The one or more extracted features may then be classified using an action classifier. For example, an action classifier may be trained based on extracted features from ego-centric videos corresponding to known actions and their corresponding action labels. In one embodiment, a support vector machine (SVM) may be trained, a neural network may be trained, a random forest (RF) may be trained, and the like.

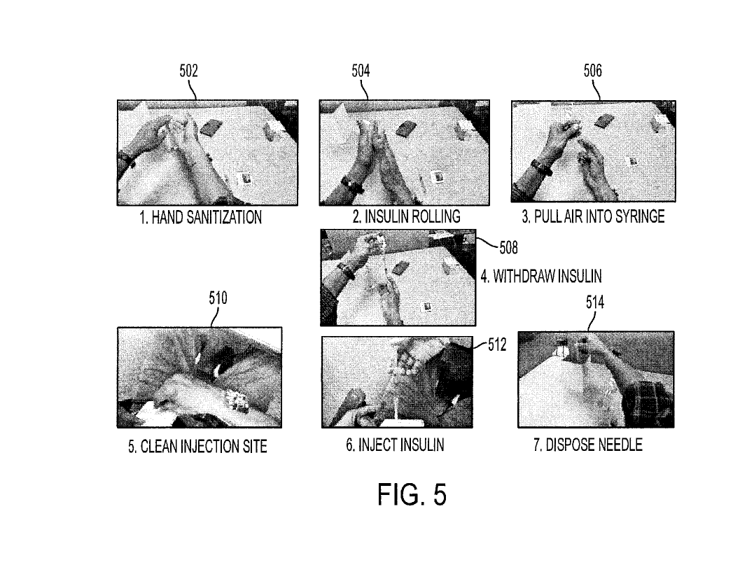

In one embodiment, the embodiments of the present disclosure may be used in a variety of applications. In one embodiment, the adaptive sampling techniques of the present disclosure may be used to verify a procedure being performed by a user (e.g., “online” procedure verification or “real-time” procedure verification). For example, a user may be wearing the head-mounted video device 100 to perform an insulin injection. FIG. 5 illustrates each step of an insulin injection. For example, the steps may include 1) hand sanitization shown in video frame 502, 2) insulin rolling shown in video frame 504, 3) pulling air into a syringe shown in video frame 506, 4) withdrawing insulin shown in video frame 508, 5) cleaning the injection site shown in video frame 510, 6) injecting insulin shown in video frame 512, and 7) disposing the syringe shown in video frame 514.

In one embodiment, as the user is recording the ego-centric video, the adaptive sampling may be performed in a sub-region that includes the user's hand. The user's hand may be detected via the hand segmentation algorithms described above. One or more features may be extracted from ST patches identified within the sub-regions that include the user's hand. An action classifier may be applied to the one or more features to identify what action is occurring in the one or more frames of the ego-centric video that are being adaptively sampled.

For example, as the user is recording himself or herself sanitizing his or her hand, the head-mounted video device 100 may detect that the action that is occurring is a hand sanitization step. For example, the head-mounted video device 100 may extract the features of the user sanitizing his or her hand and apply the action classifiers to the extracted feature of the user sanitizing his or her hand to identify that the ST patch that is analyzed is a hand sanitization step.

In one embodiment, if the user begins pulling air into a syringe (shown in video frame 506), the head-mounted video device 100 may extract the features of the user's hand using the syringe. The head-mounted video device 100 may apply the action classifier to the extracted features and identify that the ST patch that is analyzed is the step of pulling air into the syringe. However, the head-mounted video device 100 may be expecting the next step after the hand sanitization step (shown in video frame 502) to be the insulin rolling step (shown in video frame 504). The head-mounted video device 100 may detect a mismatch in the steps for the insulin injection procedure and may alert the user via the display 104 that the insulin rolling step was skipped. Thus, the adaptive sampling methods described herein may be used to ensure that a user correctly performs a procedure as the head-mounted video device 100 is recording the user performing the procedure, such as an insulin injection.

In another real-time example, an employee may be part of a manufacturing process. The employee may wear the head-mounted video device 100 while working. If the employee forgets how to assembly a product during the manufacturing process, the adaptive sampling methods disclosed herein may be turned on to assist the employee in completing the correct steps and in the correct order for assembling the product.

In another embodiment, the adaptive sampling methods disclosed herein may be used to check for compliance at a later time, or offline, for a procedure using ego-centric videos captured by the head-mounted video device. For example, ego-centric videos of surgeons washing their hands may be analyzed. The ego-centric videos may be automatically analyzed via the adaptive sampling methods to determine if the surgeons are complying with the proper hand washing procedures. Other applications of the adaptive sampling methods disclosed herein may include summarizing long video sequences, detecting anomalies, recognizing relevant activities, and the like.

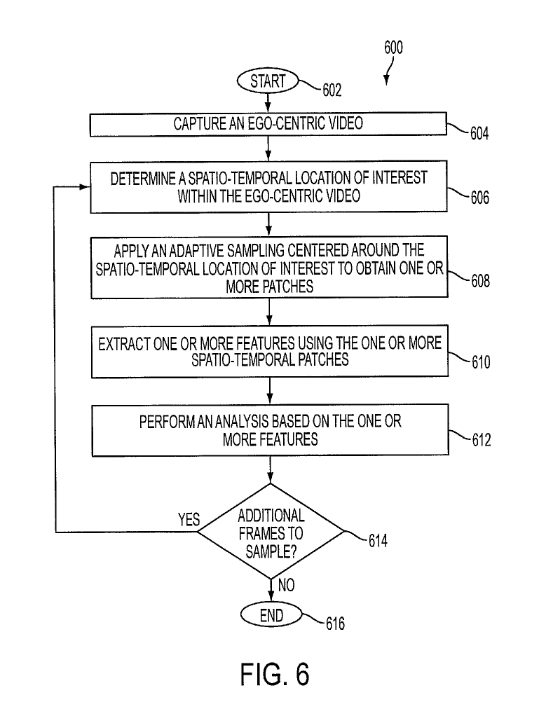

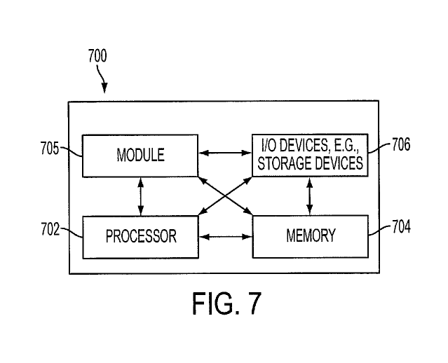

FIG. 6 illustrates a flowchart of a method 600 for adaptive sampling in ego-centric videos for performing analysis. In one embodiment, one or more steps or operations of the method 600 may be performed by the head-mounted video device 100 or a computer as illustrated in FIG. 7 and discussed below.

At step 602 the method 600 begins. At step 604, the method 600 captures an ego-centric video. For example, a user may be attempting to perform a procedure or may be required to record a procedure for compliance review. The camera on the head-mounted video device may capture an ego-centric video of the user performing the procedure.

In one embodiment, the user may signal or prompt the initiation of the acquisition of the image from the ego-centric video. For example, the signal or prompt may be an audio command, a tap or a swipe gesture.

At step 606, the method 600 determines a spatio-temporal location of interest within the ego-centric video. In one embodiment, the spatio-temporal location of interest, C, may be determined by detecting one or more pixels belonging to an object of interest. Based on a location of the one or more pixels, spatio-temporal location may be derived. In one embodiment, the spatio-temporal location, C, may be the centroid of all pixels of an object of interest in a given frame (e.g., a user's hand). Other rules may also be used. Next, a sampling probability mask P(x,y) is defined that indicates the probability of selecting a spatio-temporal patch at pixel location (x,y). The mask is centered about C.

At step 608, the method 600 applies an adaptive sampling centered around the spatio-temporal location of interest to obtain one or more spatio-temporal patches. For example, an ST patch may be obtained from a sub-region of a frame of the ego-centric video based on a location of a region of interest (e.g., a region that includes a hand identified from the hand segmentation algorithm).

As discussed above, the embodiments of the present disclosure provide a more efficient process for sampling video frames by analyzing ST patches within dynamically changing sub-regions. Traditional sampling approaches analyze a fixed sub-region of interest within an entire frame over the entire number of frames or time duration. This may result in unnecessary regions of the video frame being analyzed and/or the fixed sub-region missing objects of interest as objects of interest move within the video frame.

In contrast, the embodiments of the present disclosure improve the efficiency of sampling the video frames by sampling only ST patches of a region of interest within a sub-region. The dimensions of the sub-region may be changed for different video frames within a duration of a video to capture the object of interest as efficiently as possible. For example, if a single hand is within the video frame the sub-region may be fit around the single hand. As a result, the amount of pixels that need to be analyzed is significantly reduced. However, if the user's second hand enters the video frame, the dimensions of the sub-region may be adjusted dynamically to include both hands. At a later time, when the second hand leaves the video frame, the sub-region may be adjusted dynamically again to fit around the single hand. As a result, additional pixels that would be captured by the larger sub-region when both hands are in the video frame are not analyzed, thereby reducing the amount of processing and computations that are required.

At step 610, the method 600 extracts one or more features on the one or more spatio-temporal patches. For example, hand-engineered features may be detected using 3DSIFT, where 3DSIFT features of the ego-centric video are extracted at locations identified by the adaptive sampling. In another embodiment, a deep learning model may be used to extract features.

At step 612, the method 600 performs an analysis based on the one or more features. In one embodiment, the analysis may be an action classification based on the one or more features. For example, a trained action classifier may be used. In one embodiment, an SVM, a neural network or a random forest may be trained as the action classifier for the one or more extracted features.

At step 614, the method 600 determines if there are additional frames to sample. If the answer is yes, the method 600 returns to step 606 and repeats steps 606-614. If the answer is no, the method 600 proceeds to step 616. At step 616, the method 600 ends.

As a result, the embodiments of the present disclosure improve the technological area of wearable devices by improving the efficiency of sampling video frames of the ego-centric video captured by the wearable devices using adaptive sampling via spatio-temporal patches.

It should be noted that although not explicitly specified, one or more steps, functions, or operations of the method 600 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 6 that recite a determining operation, or involve a decision, do not necessarily require that both branches of the determining operation be practiced. In other words, one of the branches of the determining operation can be deemed as an optional step.

FIG. 7 depicts a high-level block diagram of a computer that can be transformed into a machine that is dedicated to perform the functions described herein. Notably, no computer or machine currently exists that performs the functions as described herein. As a result, the embodiments of the present disclosure improve the operation and functioning of the computer to perform adaptive sampling of ego-centric videos, as disclosed herein.

As depicted in FIG. 7 the computer 700 comprises one or more hardware processor elements 702 (e.g., a central processing unit (CPU), a microprocessor, or a multi-core processor), a memory 704, e.g., random access memory (RAM) and/or read only memory (ROM), a module 705 for adaptive sampling ego-centric videos to extract features for performing analysis, and various input/output devices 706 (e.g., storage devices, including but not limited to, a tape drive, a floppy drive, a hard disk drive or a compact disk drive, a receiver, a transmitter, a speaker, a display, a speech synthesizer, an output port and an input port). Although only one processor element is shown, it should be noted that the computer may employ a plurality of processor elements.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 805 for adaptive sampling ego-centric videos to extract features for performing analysis (e.g., a software program comprising computer-executable instructions) can be loaded into memory 704 and executed by hardware processor element 702 to implement the steps, functions or operations as discussed above. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 705 for adaptive sampling ego-centric videos to extract features for performing analysis (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for adaptive sampling of an ego-centric video to extract one or more features for performing an analysis, comprising:
capturing, by a processor, the ego-centric video;
determining, by the processor, a spatio-temporal location of interest within the ego-centric video;
applying, by the processor, an adaptive sampling centered around the spatio-temporal location of interest to obtain one or more spatio-temporal patches;
extracting, by the processor, the one or more features using the one or more spatio-temporal patches; and
performing, by the processor, the analysis based on the one or more features.

2. The method of claim 1, wherein the determining the spatio-temporal location of interest comprises:
detecting, by the processor, one or more pixels belonging to an object of interest; and
deriving, by the processor, the spatio-temporal location of interest based on a location of the one or more pixels.

3. The method of claim 2, wherein the object of interest comprises at least one of: one or more hands, a face, a human body part, a human body, a vehicle, a sign or a license plate.

4. The method of claim 3, wherein the object of interest comprises the one or more hands, and performing the analysis comprises applying a human action classifier based on the one or more features, wherein the human action classifier is trained using features that are extracted from previously captured ego-centric videos that have known actions and corresponding action labels.

5. The method of claim 4, wherein the performing the analysis further comprises verifying a procedure that is being performed by a user based on an output of the human action classifier.

6. The method of claim 1, wherein the adaptive sampling comprises generating a sampling probability mask P(x,y) that indicates a probability of selecting a spatio-temporal patch of the one or more spatio-temporal patches at a pixel location (x,y).

7. The method of claim 6, wherein the sampling probability mask takes on a value of 1 for pixels inside the spatio-temporal location of interest and a value of 0 for pixels outside the spatio-temporal location of interest.

8. The method of claim 7, wherein a shape of the spatio-temporal location of interest comprises at least one of: a cuboid, a cylinder, an elliptical cylinder, a sphere, or an ellipsoid.

9. The method of claim 8, wherein the sampling probability mask is a Gaussian function centered around the spatio-temporal location of interest and a spatio-temporal patch of the one or more spatio-temporal patches is selected when the Gaussian function is larger than a uniformly distributed random number generated in a range between 0 and 1.

10. The method of claim 9, wherein the Gaussian function is isotropic.

11. The method of claim 1, wherein the one or more spatio-temporal patches are obtained using at least one of: a scale invariant feature transform (SIFT), a histogram of oriented gradients (HOG), a local binary pattern, three dimensional (3D) SIFT, HOG-3D, space time interest points, dense trajectories or an independent subspace analysis.

12. The method of claim 1, wherein the performing the analysis comprises:
identifying, by the processor, a procedure being performed by a user; and
displaying, by the processor, a video image of a sequence of steps to complete the procedure in a display of a head-mounted video device worn by the user.

13. A non-transitory computer-readable medium storing a plurality of instructions, which when executed by a processor, cause the processor to perform operations for adaptive sampling an ego-centric video to extract one or more features for performing an analysis, comprising:
capturing the ego-centric video;
determining a spatio-temporal location of interest within the ego-centric video;
applying an adaptive sampling centered around the spatio-temporal location of interest to obtain one or more spatio-temporal patches;
extracting the one or more features using the one or more spatio-temporal patches; and
performing the analysis based on the one or more features.

14. The non-transitory computer-readable medium of claim 13, wherein the object of interest comprises at least one of: a hand, a face, a human body part, a human body, a vehicle, a sign or a license plate.

15. The non-transitory computer-readable medium of claim 13, wherein the determining the spatio-temporal location of interest comprises:
detecting one or more pixels belonging to an object of interest; and
deriving the spatio-temporal location of interest based on a location of the one or more pixels.

16. The non-transitory computer-readable medium of claim 13, wherein the adaptive sampling comprises generating a sampling probability mask P(x,y) that indicates a probability of selecting a spatio-temporal patch of the one or more spatio-temporal patches at a pixel location (x,y).

17. The non-transitory computer-readable medium of claim 16, wherein the sampling probability mask takes on a value of 1 for pixels inside the spatio-temporal location of interest and a value of 0 for pixels outside the spatio-temporal location of interest.

18. The non-transitory computer-readable medium of claim 17, wherein a shape of the spatio-temporal location of interest comprises at least one of: a cuboid, a cylinder, an elliptical cylinder, a sphere, or an ellipsoid. The non-transitory computer-readable medium of claim 16, wherein the sampling probability mask is a Gaussian function centered around the spatiotemporal location of interest and a spatio-temporal patch of the one or more spatio-temporal patches is selected when the Gaussian function is larger than a uniformly distributed random number generated in a range between 0 and 1.

20. A method for adaptive sampling an ego-centric video to extract one or more features for performing an analysis, comprising:
capturing, by a processor of a head mounted video device, the ego-centric video of a user performing a procedure involving one or more hands of the user;
performing, by the processor, a hand segmentation algorithm on frames of the ego-centric video to detect pixels that correspond to the one or more hands of the user;
determining, by the processor, a spatiotemporal location of interest within the ego-centric video based on the pixels that correspond to the one or more hands;
applying, by the processor, an adaptive sampling centered around the spatio-temporal location of interest to obtain one or more spatio-temporal patches;
extracting, by the processor, the one or more features on the one or more spatio-temporal patches, wherein the one or more features comprise a known step in the procedure;
classifying, by the processor, the one or more features that are extracted and
verifying, by the processor, that the user is correctly performing the procedure, wherein the verifying comprises applying an action classifier based on the one or more features, wherein the action classifier is trained using features that are extracted from previously captured ego-centric videos that have known actions and corresponding action labels and the verifying is based on an output of the action classifier.
